(19) United States
(12) Patent Application Publication
(10) Pub. No.: US 2021/0132542 A1
(43) Pub. Date: May 6, 2021

(54) OPTICAL WAVEGUIDE FOR A DISPLAY DEVICE

(71) Applicant: CONTINENTAL AUTOMOTIVE GMBH, Hannover (DE)

(72) Inventors: Thorsten Alexander Kern, Hamburg (DE); Felicitas Wille, Darmstadt (DE)

(73) Assignee: CONTINENTAL AUTOMOTIVE GMBH, Hannover (DE)

(21) Appl. No.: 17/121,193

(22) Filed: Dec. 14, 2020

Related U.S. Application Data
(63) Continuation of application No. PCT/EP2019/065605, filed on Jun. 13, 2019.

(30) Foreign Application Priority Data
Jun. 15, 2018 (DE) 10 2018 209 628.7

(51) Int. Cl. G03H 1/02; G02B 27/01; G02B 27/00; G03H 1/18

(52) U.S. Cl. CPC G03H 1/0272; G02B 27/0103; G03H 2001/185; G03H 1/18; G02B 27/0081

(57) ABSTRACT

The disclosure relates to an optical waveguide for a display device and to a method for producing such an optical waveguide. The optical waveguide has a substrate on which a hologram layer is arranged. A cover layer includes a light-transmissive material that has been subjected to a curing process is arranged on the hologram layer. The substrate can consist of glass. Alternatively, the substrate likewise consists of a light-transmissive material that has been subjected to a curing process.

### CROSS-REFERENCE TO RELATED APPLICATIONS

This application claims the benefit of PCT Application PCT/EP2019/065605, filed Jun. 13, 2019, which claims priority to German Application DE 10 2018 209 628.7, filed Jun. 15, 2018. The disclosures of the above applications are incorporated herein by reference.

### TECHNICAL FIELD

The disclosure relates to an optical waveguide for a display device and to a method for producing such an optical waveguide. The disclosure also relates to a device for generating a virtual image using such an optical waveguide.

### BACKGROUND

A head-up display, also referred to as a HUD, is understood to mean a display system in which the viewer can maintain their viewing direction, since the contents to be represented are superposed into their field of view. While such systems were originally primarily used in the aerospace sector due to their complexity and cost, they are now also being used in large-scale production in the automotive sector.

Head-up displays generally consist of an image generator, an optics unit, and a mirror unit. The image generator produces the image. The optics unit directs the image onto the mirror unit. The image generator is often also referred to as an image-generating unit or PGU (Picture Generating Unit). The mirror unit is a partially reflective, light-transmissive pane. The viewer thus sees the contents represented by the image generator as a virtual image and at the same time sees the real world behind the pane. In the automotive sector, the windshield is often used as the mirror unit, and the curved shape of the windshield must be taken into account in the representation. Due to the interaction of the optics unit and the mirror unit, the virtual image is an enlarged representation of the image produced by the image generator.

The viewer can view the virtual image only from the position of what is known as the eyebox. A region whose height and width correspond to a theoretical viewing window is called an eyebox. As long as one eye of the viewer is within the eyebox, all elements of the virtual image are visible to that eye. If, on the other hand, the eye is outside the eyebox, the virtual image is only partially visible to the viewer, or not at all. The larger the eyebox is, the less restricted the viewer is in choosing their seating position.

The size of the virtual image of conventional head-up displays is limited by the size of the optics unit. One approach for enlarging the virtual image is to couple the light coming from the image-generating unit into an optical waveguide. The light that is coupled into the optical waveguide and carries the image information undergoes total internal reflection at the interfaces thereof and is thus guided within the optical waveguide. In addition, a portion of the light is in each case coupled out at a multiplicity of positions along the propagation direction, so that the image information is output distributed over the surface of the optical waveguide. Owing to the optical waveguide, the exit pupil is in this way expanded. The effective exit pupil is composed here of images of the aperture of the image production system.

Against this background, US 2016/0124223 A1 describes a display apparatus for virtual images. The display apparatus includes an optical waveguide that causes light that is coming from an image-generating unit and is incident through a first light incidence surface to repeatedly undergo internal reflection in order to move in a first direction away from the first light incidence surface. The optical waveguide also has the effect that a portion of the light guided in the optical waveguide exits to the outside through regions of a first light exit surface that extends in the first direction. The display apparatus further includes a first light-incidence-side diffraction grating that diffracts incident light to cause the diffracted light to enter the optical waveguide, and a first light-emergent diffraction grating that diffracts the light that is incident from the optical waveguide.

A conventional full-color head-up display based on optical waveguides usually includes three monochrome optical waveguides lying one above the other, one each for the colors red, green, and blue. These optical waveguides each consist of a glass substrate, a thin hologram layer, and a further glass substrate as a cover layer. The glasses are in this case typically thicker than 1 mm. In addition, they are stiff and robust against bending.

The substrates for producing such an optical waveguide must have very good surface properties, for example with regard to flatness. Such properties without complex surface treatment of the substrates are obtainable on the market only with great difficulty and at high prices. In addition, the substrate thickness leads to an increased structure of the optical waveguide consisting of three monochrome optical waveguides. This in turn leads to an increased structure of the entire product containing the optical waveguide, for example of a head-up display. In addition, there are superposition errors of the colors which are transported in each case through one of the monochrome optical waveguides if the optical waveguides are viewed at a steep angle. This is often the case when used as a head-up display in motor vehicles.

### SUMMARY

The disclosure provides an improved optical waveguide and methods for producing such an optical waveguide.

According to a first aspect of the disclosure, an optical waveguide for a display device includes: a substrate; a hologram layer arranged on the substrate; and a cover layer arranged on the hologram layer. The cover layer consists of a light-transmissive material that has been subjected to a curing process.

Implementations of the disclosure may include one or more of the following optional features. In some implementations, an optical waveguide has a substrate, a cover layer, and an optically active layer located between these two. The cover layer here consists of a light-transmissive material that has been subjected to a curing process. The cover layer is applied in a mold having an exactly specified geometry and cured. The cover layer thus has an exact surface shape without having to be reworked in a costly manner. Fluctuations in the quality of the surfaces, as they occur with the glass substrates previously used as cover layer, are avoided. The high quality of the shaped surfaces additionally results in a significant improvement in the total internal reflection in terms of a reduction in angle errors.

Another advantage is that there is no need to use a plurality of relatively thick glass substrates for one optical waveguide. This permits a reduced-thickness design of the optical waveguide. In addition, the production of the cover layer is more cost-effective than the use of the glass substrates with corresponding surface properties currently available on the market.

According to one aspect of the disclosure, the substrate consists of glass or also of a light-transmissive material that has been subjected to a curing process.

In some examples of the optical waveguide according to the disclosure, the substrate consists of glass. This has the advantage that the glass substrate can serve as a mechanically stable carrier.

In other examples of the optical waveguide according to the disclosure, the substrate also consists of a light-transmissive material that has been subjected to a curing process. This has the advantage that the substrate may also be produced cost-effectively and yet have the desired surface properties. In addition, an optical waveguide that is flexible to a certain extent can be implemented in this way.

The same light-transmissive material may be used for the substrate and the cover layer, but different materials may also be used.

According to yet another aspect of the disclosure, the light-transmissive material is a lacquer or an optically clear adhesive (OCA), in other words a curing adhesive. The latter usually has a refractive index that corresponds to the transparent materials that are to be bonded by it. Such adhesives are known to a person skilled in the art and can be adjusted very well to a desired refractive index, in the present case that of the glass that is used or is to be replaced. The materials mentioned have the advantage of being inexpensive and easy to process.

According to another aspect of the disclosure, the light-transmissive material that has been subjected to a curing process has a refractive index of greater than or equal to 1.4. It therefore has optical properties that correspond to those of glass and can be used as a replacement for otherwise used glass without the need for time-consuming recalculation of the optical properties. A refractive index of n=1.5±0.02 has proven to be suitable for use in optical waveguides.

According to another aspect of the disclosure, the substrate or the cover layer has a structuring. By using molds with an exactly specified geometry, it is possible, as an alternative to a flat material layer, to specifically structure the shape of the material layer in order to achieve different thicknesses of the lacquer layer or of the optical waveguide in different regions. These are, for example, depressions or elevations in the low millimeter range.

According to a further aspect of the disclosure, a method for producing an optical waveguide includes the steps of: applying a layer of a light-transmissive material onto a first mold plate; curing the applied light-transmissive material to form a cover layer; applying a hologram layer onto the cover layer; applying a substrate onto the hologram layer; and exposing the hologram layer to light and curing it.

For the example of the optical waveguide in which the substrate consists of glass, the material, for example a lacquer or an optically clear adhesive, is applied, for the production of the material layer, onto a mold plate, in other words to a reference surface that has the desired properties, in particular with regard to flatness. The material is then cured. Subsequently, a thin holographic layer is applied, the layer thickness of which can be defined using spacers. Finally, a glass substrate is applied onto the structure made of a material layer and a thin hologram layer, and the hologram layer is exposed to light and cured. The exposure and curing of the thin hologram layer is possible before and after the glass substrate has been applied.

One advantage of the method described is the elimination of a glass for the construction of an optical waveguide. In addition, the properties of the mold plate of the injection mold, such as, for example, its flatness, are transferred to the cover layer formed on it. This results in surface properties that exceed even the properties of glass materials.

According to a further aspect of the disclosure, a method for producing an optical waveguide includes the steps of: applying a layer of a light-transmissive material onto a first mold plate; curing the applied light-transmissive material to form a cover layer; applying a hologram layer onto the cover layer; exposing the hologram layer to light and curing it; applying a layer of a light-transmissive material onto the hologram layer; shaping the applied light-transmissive material by means of a second mold plate; and curing the applied light-transmissive material to form a substrate.

For the example of the optical waveguide in which neither the substrate nor the cover layer consists of glass, the material, for example a lacquer or an optically clear adhesive, is applied, for the production of the material layer, onto a mold plate, in other words onto a reference surface, which has the desired properties, in particular with regard to flatness. The material is then cured. A thin holographic layer is then applied, the layer thickness of which can be defined using spacers. The hologram layer is then exposed to light and cured. For the realization of the second material layer, which for example likewise consists of a lacquer or an optically clear adhesive, the material is applied onto the hologram layer. The surface of the material layer is molded by a counterplate that is brought into contact with the material layer under the action of force.

One advantage of the method described is the elimination of two glasses for the construction of an optical waveguide. In addition, the properties of the mold plate of the injection mold, such as, for example, its flatness, are transferred to the cover layer formed on it.

The two material layers can also be used as carrier material for transferring the thin holographic layer onto a substrate or onto another waveguide, since the material layers can be detached from the thin hologram layer without damaging it.

According to another aspect of the disclosure, a separating layer is arranged between the first mold plate and the layer of the light-transmissive material or between the second mold plate and the layer of the light-transmissive material. One or more further layers may be inserted between the mold plates and the respective adjoining material layers, which further layers serve for better detachability of the material layers from the respective mold plate. This is useful when the material used is an adhesive that, without any further layer located between it and the mold plate, can only be detached from the mold plate with a certain amount of effort.

According to yet another aspect of the disclosure, the first mold plate or the second mold plate has a structuring. As an alternative to a flat material layer, a specific structuring of the shape of the material layer can also be achieved by structuring the mold plates. In this way, different thicknesses of the lacquer layer or of the optical waveguide in different regions can be implemented. These are, for example, depressions or elevations in the low millimeter range.

According to a further aspect of the disclosure, a device for generating a virtual image includes: an image-generating unit for producing an image; an optics unit for projecting the image in the direction of a mirror unit for generating the virtual image; and an optical waveguide according to the disclosure for expanding an exit pupil.

The optical waveguide according to the disclosure makes it possible to implement head-up displays that have a reduced space requirement. The use of full-color head-up displays based on optical waveguides, in which three monochrome optical waveguides lying one above the other are required, is particularly advantageous.

A device according to the disclosure for generating a virtual image may be used in a means of transport in order to produce a virtual image for an operator of the means of transport. The means of transport can be, for example, a motor vehicle or an aircraft. Of course, the solution according to the disclosure can also be used in other environments or for other applications, e.g. in trucks, in rail technology, and in public transport, in cranes and construction machinery, etc.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 schematically shows a head-up display according to the prior art for a motor vehicle;

FIG. 2 shows an optical waveguide with two-dimensional enlargement;

FIG. 3 schematically shows a head-up display with an optical waveguide;

FIG. 4 schematically shows a head-up display with an optical waveguide in a motor vehicle;

FIG. 5 shows three examples of an optical waveguide in longitudinal section;

FIG. 6 schematically shows a first embodiment of an optical waveguide according to the disclosure;

FIG. 7 schematically shows a second embodiment of an optical waveguide according to the disclosure;

FIG. 8 shows a production detail for the optical waveguide from FIG. 7;

FIG. 9 schematically shows a first production method for an optical waveguide according to the disclosure;

FIG. 10 shows a modification of the production method from FIG. 9; and

FIG. 11 schematically shows a second production method for an optical waveguide according to the disclosure.

Like reference symbols in the various drawings indicate like elements.

### DETAILED DESCRIPTION

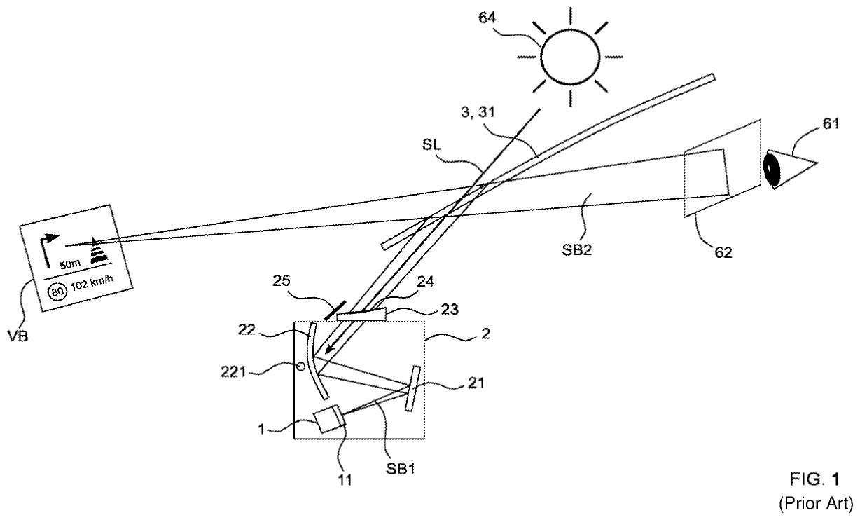

Initially, the basic concept of a head-up display with an optical waveguide will be explained with reference to FIGS. 1 to 4.

FIG. 1 shows a schematic diagram of a head-up display according to the prior art for a motor vehicle. The head-up display has an image generator 1, an optics unit 2, and a mirror unit 3. A beam bundle SB1 emanates from a display element 11 and is reflected by a folding mirror 21 onto a curved mirror 22 that reflects it in the direction of the mirror unit 3. The mirror unit 3 is illustrated here as a windshield 31 of a motor vehicle. From there, the beam bundle SB2 travels in the direction of an eye 61 of a viewer.

The viewer sees a virtual image VB that is located outside the motor vehicle above the engine hood or even in front of the motor vehicle. Due to the interaction of the optics unit 2 and the mirror unit 3, the virtual image VB is an enlarged representation of the image displayed by the display element 11. A speed limit, the current vehicle speed, and navigation instructions are symbolically represented here. As long as the eye 61 is located within the eyebox 62 indicated by a rectangle, all elements of the virtual image are visible to that eye 61. If the eye 61 is outside the eyebox 62, the virtual image VB is only partially visible to the viewer, or not at all. The larger the eyebox 62 is, the less restricted the viewer is when choosing their seating position.

The curvature of the curved mirror 22 is adapted to the curvature of the windshield 31 and ensures that the image distortion is stable over the entire eyebox 62. The curved mirror 22 is rotatably mounted by way of a bearing 221. The rotation of the curved mirror 22 that is made possible thereby makes it possible to displace the eyebox 62 and thus to adapt the position of the eyebox 62 to the position of the eye 61. The folding mirror 21 serves to ensure that the path traveled by the beam bundle SB1 between the display element 11 and the curved mirror 22 is long and, at the same time, that the optics unit 2 is nevertheless compact. The optics unit 2 is delimited with respect to the environment by a transparent cover 23. The optical elements of the optics unit 2 are thus protected for example against dust located in the interior of the vehicle. An optical film or a polarizer 24 is furthermore located on the cover 23. The display element 11 is typically polarized, and the mirror unit 3 acts like an analyzer. The purpose of the polarizer 24 is therefore to influence the polarization in order to achieve uniform visibility of the useful light. An anti-glare protection 25 serves to reliably absorb the light reflected via the interface of the cover 23 so that the observer is not dazzled. In addition to the sunlight SL, the light from another stray light source 64 can also reach the display element 11. In combination with a polarization filter, the polarizer 24 can additionally be used to block out incident sunlight SL.

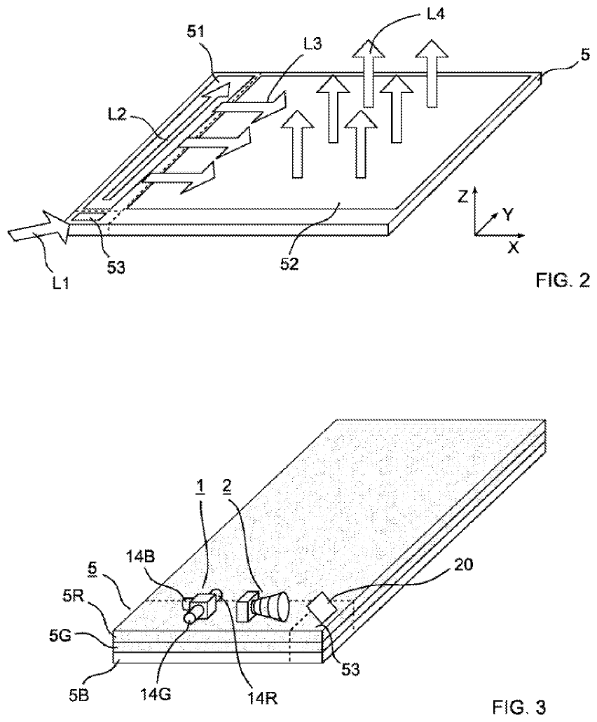

FIG. 2 shows a schematic spatial illustration of an optical waveguide 5 with two-dimensional enlargement. In the lower left region, an input coupling hologram 53 can be seen, by way of which light L1 coming from an image-generating unit (not shown) is coupled into the optical waveguide 5. The light propagates therein in the drawing to the top right, according to the arrow L2. In this region of the optical waveguide 5, a folding hologram 51 that acts similarly to many partially transmissive mirrors arranged one behind the other and produces a light bundle that is expanded in the Y-direction and propagates in the X-direction is located. This is indicated by three arrows L3. In the part of the optical waveguide 5 that extends to the right in the figure, an output coupling hologram 52 is located, which likewise acts similarly to many partially transmissive mirrors arranged one behind the other and, indicated by arrows L4, couples light upward in the Z-direction out of the optical waveguide 5. In this case, an expansion takes place in the X-direction, so that the original incident light bundle L1 leaves the optical waveguide 5 as a light bundle L4 that is enlarged in two dimensions.

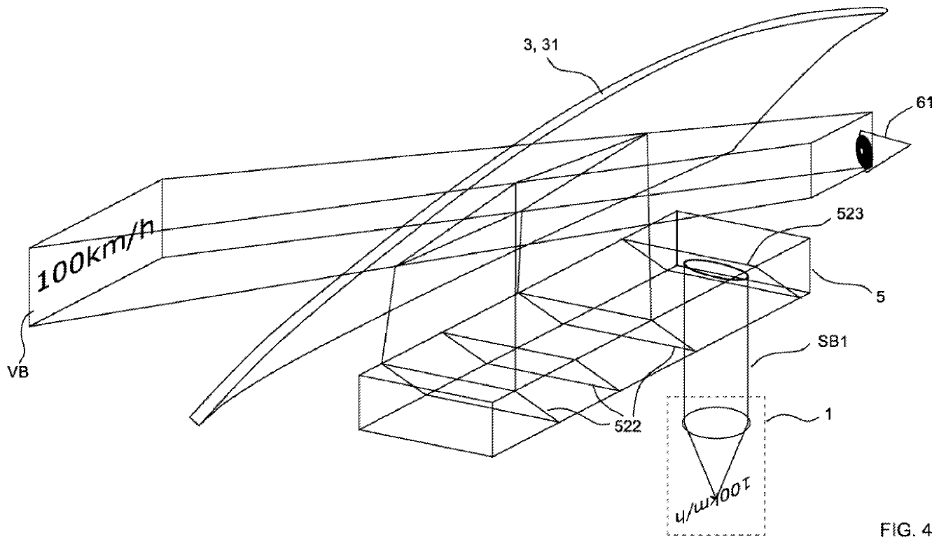

FIG. 3 shows a three-dimensional illustration of a head-up display with three optical waveguides 5R, 5G, 5B, which are arranged one above the other and each stand for an elementary color red, green, and blue. Together they form the optical waveguide 5. The holograms 51, 52, 53 present in the optical waveguide 5 are wavelength-dependent, meaning that one optical waveguide 5R, 5G, 5B in each case is used for one of the elementary colors. An image generator 1 and an optics unit 2 are shown above the optical waveguide 5. The optics unit 2 has a mirror 20, by way of which the light produced by the image generator 1 and shaped by the optics unit 2 is deflected in the direction of the respective input coupling hologram 53. The image generator 1 has three light sources 14R, 14G, 14B for the three elementary colors. It can be seen that the entire unit shown has a small overall structural height compared to its light-emitting surface.

FIG. 4 shows a head-up display in a motor vehicle similar to FIG. 1, except here in a three-dimensional illustration and with an optical waveguide 5. It shows the schematically indicated image generator 1, which produces a parallel beam bundle SB1 that is coupled into the optical waveguide 5 by way of the mirror plane 523. The optics unit is not shown for the sake of simplicity. A plurality of mirror planes 522 each reflect a portion of the light incident on them in the direction of the windshield 31, the mirror unit 3. The light is reflected thereby in the direction of the eye 61. The viewer sees a virtual image VB above the engine hood or at an even further distance in front of the motor vehicle. With this technology, too, the entire optics unit is incorporated in a housing that is separated with respect to the environment by a transparent cover. As with the head-up display from FIG. 1, a retarder can be arranged on this cover.

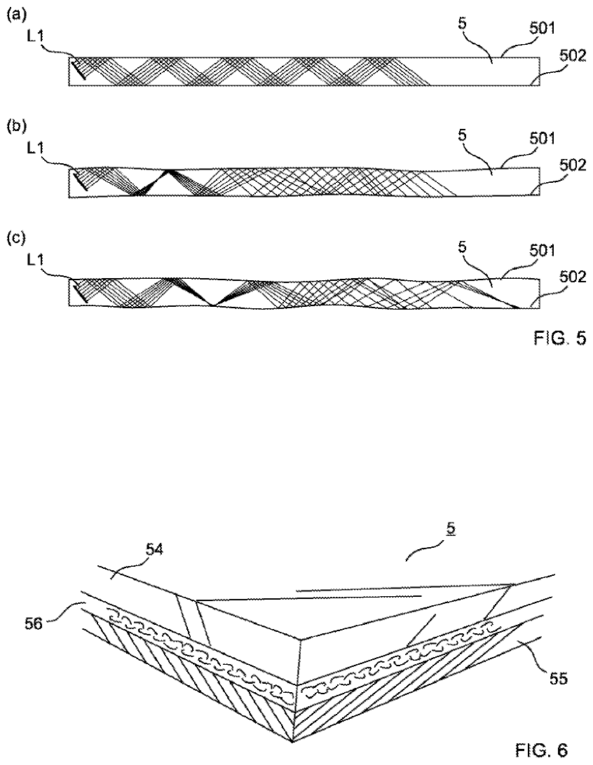

FIG. 5 shows three examples of an optical waveguide 5 in longitudinal section. The optical waveguide 5 in partial image (a) has an ideally flat upper boundary surface 501 and an ideally flat lower boundary surface 502, both of which are arranged parallel to one another. It can be seen that a parallel light bundle L1 propagating from left to right in the optical waveguide 5 remains unchanged and parallel in cross section due to the parallelism and flatness of the upper and lower boundary surfaces 501, 502. The optical waveguide 5 in partial image (b) has upper and lower boundary surfaces 501, 502 that are not completely flat and also not parallel to one another. The optical waveguide 5 thus has a thickness that varies in the light propagation direction. It can be seen that the light bundle L1 is no longer parallel after just a few reflections and also does not have a homogeneous cross section. The optical waveguide 5 in partial image (c) has upper and lower boundary surfaces 501, 502 that deviate even more from the ideal shape than those in partial image (b). The light bundle L1 therefore likewise deviates even more from the ideal shape. The flatness of the boundary surfaces 501, 502 is therefore of great importance for the quality of the light propagation in the optical waveguide.

FIG. 6 shows a first example of an optical waveguide 5 according to the disclosure. In this example, a substrate 54 made of glass is used. A thin hologram layer 56 is arranged on the substrate 54. A cover layer 55 consisting of a light-transmissive material that has been subjected to a curing process is arranged on the hologram layer 56. The light-transmissive material can be, for example, a lacquer or an optically clear adhesive. The refractive index of the material may be greater than or equal to 1.4. If necessary, the cover layer 55 can have a structuring.

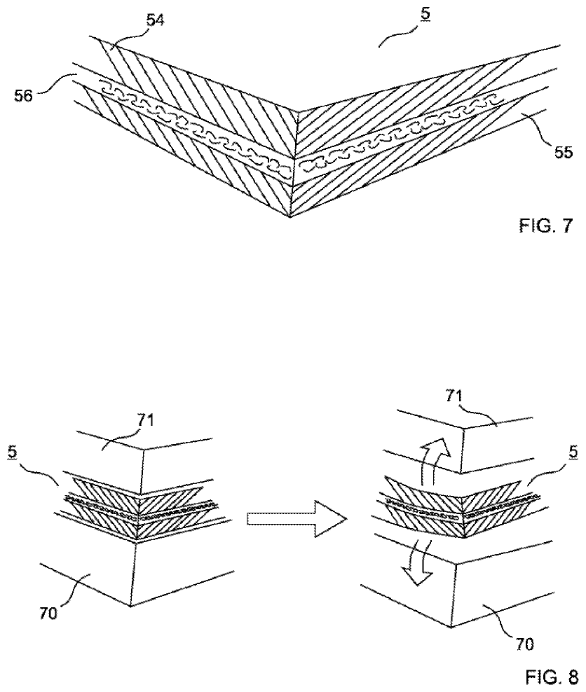

FIG. 7 shows a second example of an optical waveguide 5 according to the disclosure. In this example, a substrate 54 that likewise consists of a light-transmissive material that has been subjected to a curing process is used. A thin hologram layer 56, onto which a cover layer 55 is applied, is in turn arranged on the substrate 54. As before, the cover layer 55 consists of a light-transmissive material that has been subjected to a curing process. The same light-transmissive material may be used for the substrate 54 and the cover layer 55, but different materials can also be used. In this example too, the light-transmissive material can be a lacquer or an optically clear adhesive. The refractive index may be greater than or equal to 1.4 here as well. If necessary, the substrate 54 or the cover layer 55 can have a structuring.

FIG. 8 shows a production detail for the optical waveguide 5 from FIG. 7. For the production of this construction, two mold plates 70, 71 having the desired surface properties are used. To remove the optical waveguide 5 from the manufacturing construction, the mold plates 70, 71 are separated, where the optical waveguide 5 becomes detached from the mold plates 70, 71.

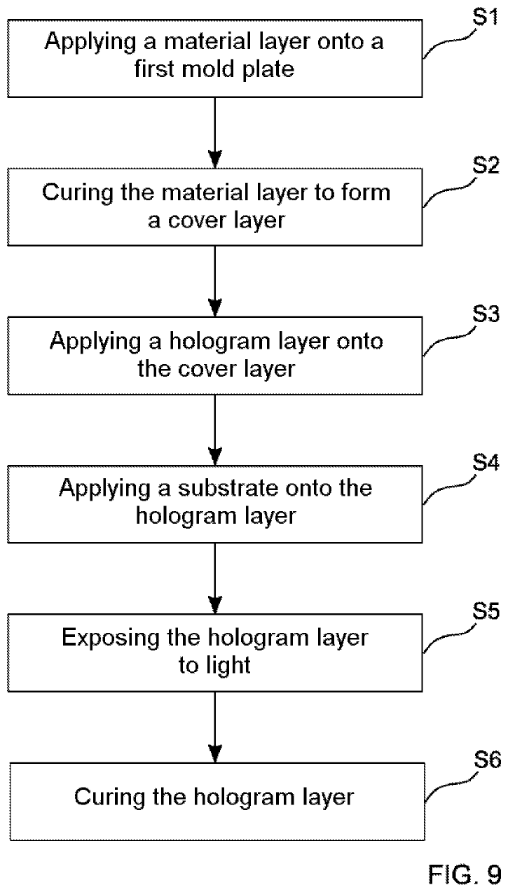

FIG. 9 schematically shows a first production method for an optical waveguide according to the disclosure. First, a layer of a curable, light-transmissive material is applied S1 onto a first mold plate. This layer is cured S2 to form the cover layer. A hologram layer is then applied S3 onto the cover layer. A substrate is then applied S4 onto this hologram layer, and the hologram layer 56 is exposed S5 to light and cured S6.

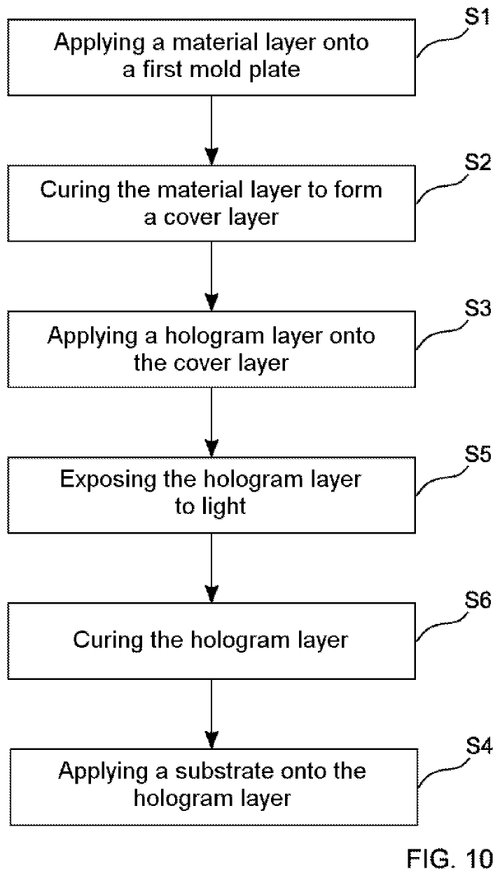

FIG. 10 shows, in a schematic form, a production method for an optical waveguide according to the disclosure that is modified compared to FIG. 9. According to this advantageous variant, exposure S5 and curing S6 take place before the substrate is applied S4. The remaining steps correspond to those from FIG. 9.

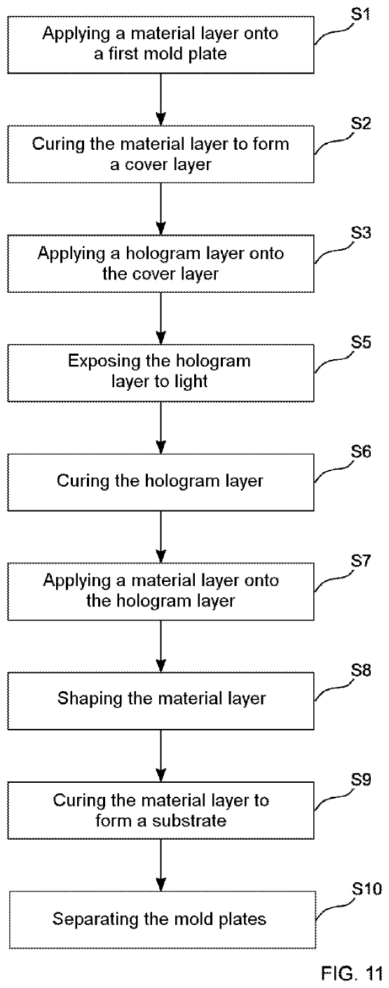

FIG. 11 schematically shows a further production method for an optical waveguide according to the disclosure. First, a layer of a curable, light-transmissive material is applied S1 onto a lower mold plate. This layer is cured S2 to form the cover layer. This is followed by the application S3 of a hologram layer onto the cover layer and the exposure S5 and curing S6 of the hologram layer. This is followed by application S7 of a further layer of a curable, light-transmissive material onto the cured hologram layer. A second mold plate is used to shape S8 the material layer, which is followed by the curing S9 of the material layer to form the substrate. Finally, the mold plates are separated S10, where the optical waveguide becomes detached from the mold plates.

In all examples of the method, one or more further layers, which serve as separating layers for better detachability of the material layers from the respective mold plate, may be inserted between the mold plates and the respective adjoining material layers.

A number of implementations have been described. Nevertheless, it will be understood that various modifications may be made without departing from the spirit and scope of the disclosure. Accordingly, other implementations are within the scope of the following claims.

### LIST OF REFERENCE ELEMENTS

1 Image generator/image-generating unit

11 Display element

14, 14R, 14G, 14B Light source

2 Optics unit

20 Mirror

21 Folding mirror

22 Curved mirror

221 Bearing

23 Transparent cover

24 Optical film/polarizer

25 Anti-glare protection

3 Mirror unit

31 Windshield

5 Optical waveguide

501 Upper boundary surface

502 Lower boundary surface

51 Folding hologram

52 Output coupling hologram

521 Output coupling region

522 Mirror plane

523 Mirror plane

53 Input coupling hologram

531 Input coupling region

54 Substrate

55 Cover layer

56 Hologram layer

61 Eye/viewer

62 Eyebox

64 Stray light source

70 First mold plate

71 Second mold plate

L1 . . . L4 Light

S1 Application of a material layer onto a first mold plate

S2 Curing the material layer to form a cover layer

S3 Applying a hologram layer onto the cover layer

S4 Applying a substrate onto the hologram layer

S5 Exposing the hologram layer to light

S6 Curing the hologram layer

S7 Applying a material layer onto the hologram layer

S8 Shaping the material layer

S9 Curing the material layer to form a substrate

S10 Separating the mold plates

SB1, SB2 Beam bundles

SL Sunlight

VB Virtual image

What is claimed is:

1. An optical waveguide for a display device, the optical waveguide comprising:
a substrate;
a hologram layer arranged on the substrate; and
a cover layer arranged on the hologram layer;
wherein the cover layer includes a light-transmissive material that has been subjected to a curing process.

2. The optical waveguide as claimed in claim 1, wherein the substrate includes glass or also of a light-transmissive material that has been subjected to a curing process.

3. The optical waveguide as claimed in claim 1, wherein the light-transmissive material is a lacquer or an optically clear adhesive.

4. The optical waveguide as claimed in claim 3, wherein the light-transmissive material that has been subjected to a curing process has a refractive index of greater than or equal to 1.4.

5. The optical waveguide as claimed in claim 1, wherein the substrate or the cover layer has a structuring.

6. A method for producing an optical waveguide, the method comprising the steps of:
applying a layer of a light-transmissive material onto a first mold plate;
curing the applied light-transmissive material to form a cover layer;
applying a hologram layer onto the cover layer;
applying a substrate onto the hologram layer; and
exposing the hologram layer to light and curing the hologram layer.

7. The method as claimed in claim 6, wherein a separating layer is arranged between the first mold plate and the layer of the light-transmissive material or between a second mold plate and the layer of the light-transmissive material.

8. The method as claimed in one of claims 6, wherein the first mold plate or a second mold plate has a structuring.

9. A method for producing an optical waveguide, the method comprising the steps of:
applying a layer of a light-transmissive material onto a first mold plate;
curing the applied light-transmissive material to form a cover layer;
applying a hologram layer onto the cover layer;
exposing the hologram layer to light and curing the hologram layer;
applying a layer of a light-transmissive material onto the hologram layer;
shaping the applied light-transmissive material by a second mold plate; and
curing the applied light-transmissive material to form a substrate.

10. The method as claimed in claim 9, wherein a separating layer is arranged between the first mold plate and the layer of the light-transmissive material or between the second mold plate and the layer of the light-transmissive material.

11. The method as claimed in one of claim 7, wherein the first mold plate or the second mold plate has a structuring.

12. A device for generating a virtual image, the device comprising:
an image-generating unit for producing an image; and
an optics unit for projecting the image in the direction of a mirror unit for generating the virtual image;
wherein the device has at least one optical waveguide as claimed in claim 1 for expanding an exit pupil.
